(19) United States
(12) Patent Application Publication
(10) Pub. No.: US 2011/0233803 A1
(43) Pub. Date: Sep. 29, 2011

(54) METAL MOLD HOLDING METHOD, ANNULAR MEMBER MANUFACTURING METHOD AND ANNULAR MEMBER MANUFACTURING APPARATUS

(75) Inventor: Yuji HARA, Kanagawa (JP)

(73) Assignee: FUJI XEROX CO., LTD., Tokyo (JP)

(21) Appl. No.: 12/856,149

(22) Filed: Aug. 13, 2010

(30) Foreign Application Priority Data
Mar. 26, 2010 (JP) 2010-072816

(51) Int. Cl. B29C 41/52; B22D 25/00; B22D 46/00; B28B 1/20; B29C 41/46

(52) U.S. Cl. 264/40.1; 164/1; 164/4.1; 264/310; 425/438; 425/150

(57) ABSTRACT

A metal mold holding method includes: rotating a metal mold by a first rotating portion; rotating a holding member by a second rotating portion in the same direction as that of the metal mold such that a difference between a speed of rotation of the holding member and that of the metal mold which rotates is smaller than a difference between the speed of rotation of the holding member and that of the metal mold in a case where the speed of rotation of the metal mold is zero; and holding the metal mold which rotates by the holding member which rotates.

### CROSS-REFERENCE TO RELATED APPLICATION

This application is based on and claims priority under 35 USC 119 from Japanese Patent Application No. 2010-072816 filed Mar. 26, 2010.

### BACKGROUND

### Technical Field

The present invention relates to a metal mold holding method, an annular member manufacturing method and an annular member manufacturing apparatus.

### SUMMARY

An aspect of the invention is a metal mold holding method including: rotating a metal mold by a first rotating portion; rotating a holding member by a second rotating portion in the same direction as that of the metal mold such that a difference between a speed of rotation of the holding member and that of the metal mold which rotates is smaller than a difference between the speed of rotation of the holding member and that of the metal mold in a case where the speed of rotation of the metal mold is zero; and holding the metal mold which rotates by the holding member which rotates.

### BRIEF DESCRIPTION OF THE DRAWINGS

Exemplary embodiment of the invention will be described in detail with reference to the following figures, wherein:

FIG. 1 is a schematic diagram showing the structure of an annular member manufacturing apparatus according to an exemplary embodiment of the invention.

FIG. 2 is a schematic diagram showing the structure of a supporting device according to an exemplary embodiment of the invention.

FIG. 3 is a cross sectional view taken along line A-A in FIG. 2.

FIG. 4 is a perspective view showing a cleaning section according to an exemplary embodiment of the invention.

FIG. 5 is a schematic diagram showing a state in which a core body according to an exemplary embodiment of the invention is held by a holding member.

FIG. 6 is a perspective view showing the structure of an applying section according to an exemplary embodiment of the invention.

FIG. 7 is a side view showing the structure of an applying section according to an exemplary embodiment of the invention.

FIG. 8 is a schematic diagram showing the structure of a drying section according to an exemplary embodiment of the invention.

FIG. 9 is a perspective view showing the structure of a firing section according to an exemplary embodiment of the invention.

### DETAILED DESCRIPTION

An example of an exemplary embodiment according to the invention is described below on the basis of the attached drawings.

### Structure of a Manufacturing Apparatus 10 of an Annular Member According to the Exemplary Embodiment

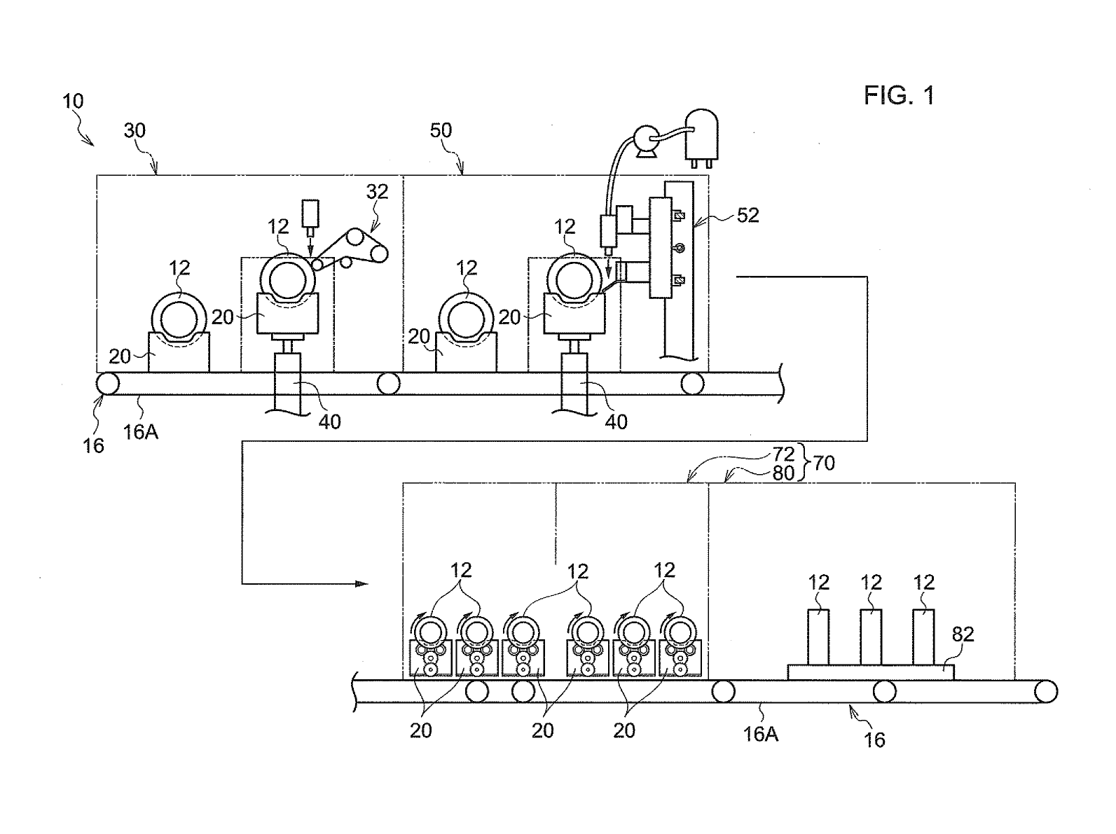

First, the structure of the manufacturing apparatus 10 of the annular member according to an exemplary embodiment of the invention (hereinafter referred to as a “annular member manufacturing apparatus 10”) is described. FIG. 1 is a schematic diagram showing the structure of the annular member manufacturing apparatus 10 according to the exemplary embodiment.

The annular member manufacturing apparatus 10 according to the exemplary embodiment is an apparatus used for manufacturing an annular member. The annular member manufactured by the annular member manufacturing apparatus 10 is an endless tubular body, which is suitably used as a photoreceptor, an intermediate transfer belt, an intermediate transfer body, a fixing belt, a transporting belt, a charging roll, a transfer roll, a development roll and the like in an electrophotographic reproducing machine, a laser printer and the like, and material, shape, size and the like of the annular member are appropriately set depending on its uses and functions.

As shown in FIG. 1, the annular member manufacturing apparatus 10 is equipped with: a cleaning section 30 in which a core body 12 which is an example of a metal mold is cleaned; an applying section 50 which is an example of an applying unit which applies a resin solution 54 to the core body 12; and a heating section 70 which is an example of a heating unit in which the resin solution 54 applied by the applying section 50 is heated and hardened (cured). The heating section 70 also includes a heating portion 72 in which a liquid-like applied film 14 formed by applying the resin solution 54 from the applying section 50 is dried, and a firing (baking) portion 80 which causes the applied film 14 dried by the drying portion 72 to be fired (baked).

Further, the annular member manufacturing apparatus 10 is also equipped with a supporting device 20 which supports the core body 12 in a rotatable manner, and a transport section 16 by which the supporting device 20 is transported in the cleaning section 30, the applying section 50, the drying section 72 and the firing section 80.

### (Structure of Core Body 12)

The core body 12 is formed into a cylindrical circular pipe shape. Incidentally, the core body 12 may also be formed into a circular column shape. Further, although described later, in a configuration in which a pair of holding members 46 holds the core body 12 with the inner periphery end portions of the core body 12, it suffices that the core body 12 may be formed in such a manner that at least both end portions thereof in the axial direction are each formed into a circular pipe shape and an inner space is not formed in a middle (central) portion of the core body in the axial direction.

Further, for the core body 12, metal such as aluminum, nickel alloy, stainless steel or the like is used. Incidentally, it is desirable that the outer peripheral surface of the core body 12 is made to be rough surface from the standpoint of restraining occurrence of swelling on the applied film 14, which is influenced by a solvent remaining in the applied film 14 or a by-product matter such as water, at the time of heating the applied film 14 which is formed on the outer peripheral surface of the core body 12.

Specifically, it is desirable that the arithmetical mean (average) roughness (Ra) of the outer peripheral surface is set in the range of 0.2 to 2.0 μm. If the outer peripheral surface of the core body 12 is roughened in the above-described range, at the time of drying and firing the applied film 14 formed on the core body 12, vapor of water or the remaining solvent generating from the applied film 14 is discharged out through a very narrow clearance between the core body 12 and the applied film 14. For this reason, occurrence of swelling in the applied film 14 is restrained.

As a method of roughening the outer peripheral surface of the applied film 14, there are methods such as blast treatment, cutting, sand paper finish, and the like. In particular, in order that the inner surface of the applied film 14 is made spherical convex, the outer peripheral surface of the core body 12 is preferably subjected to blast treatment using spherical particles. The blast treatment using spherical particles is a method in which particles whose diameter is about from equal to or more than 0.1 mm and equal to are less than 1 mm, such as glass particles, alumina particles or zirconia particles are blown against the core body by means of compressed air. In a case in which alumina particles having non-determined shape (having non-uniform shape) (for example, general abrasive particles) are used as the particles, the shape of the outer peripheral surface of the core body 12 also becomes non-determined shape, in particular, acute projections or depressions are apt to be formed, so acute projections or depressions are also formed in the inner peripheral surface of the annular member to be manufactured. The aforementioned method is not preferable.

A mold release layer is formed on the outer peripheral surface of the core body 12. The mold release layer is formed by uniformly applying a mold release agent entirely on the outer peripheral surface of the core body 12. As a result, the entire region of the outer peripheral surface of the core body 12 is brought into a state of being releasable from a mold. A mold release agent in which silicone-based or fluorine-based oil is modified so as to have heat resistance is effectively used. Further, a water-based mold release agent in which microscopic particles of silicone resin are dispersed in water is also used. Formation of the mold release layer is carried out in such a manner that the mold release agent is applied to the outer peripheral surface of the core body 12, and the solvent is only dried, or is dried and then fired.

### (Structure of Supporting Device 20)

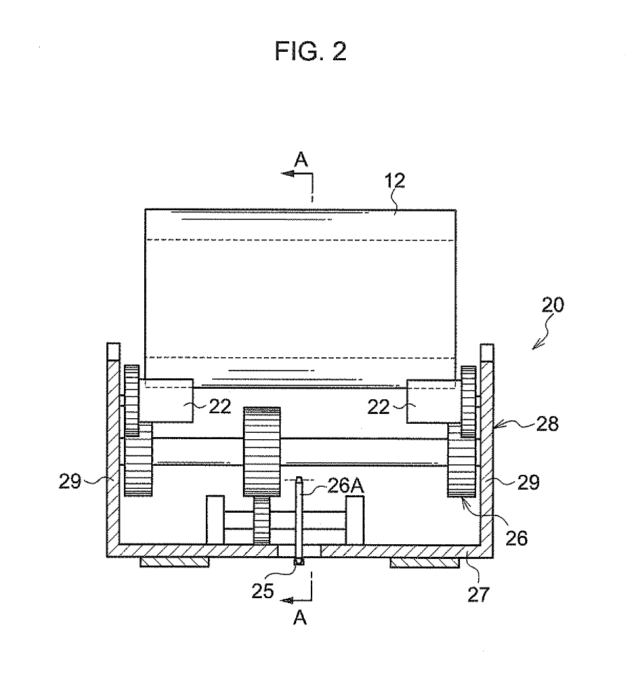

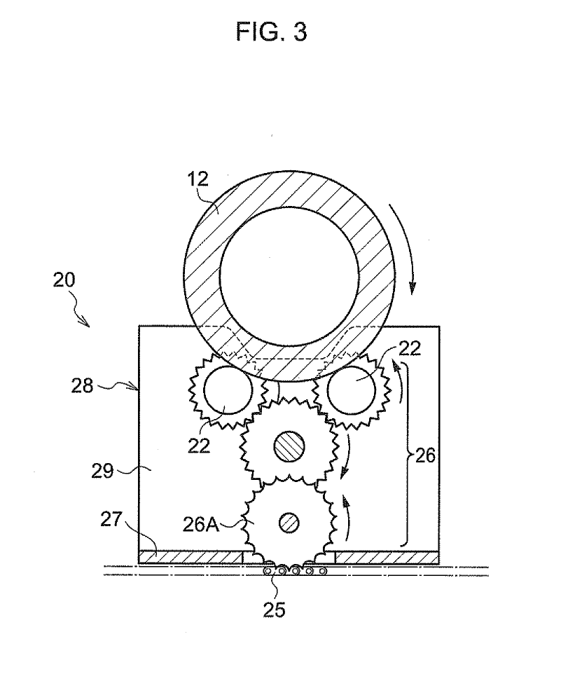

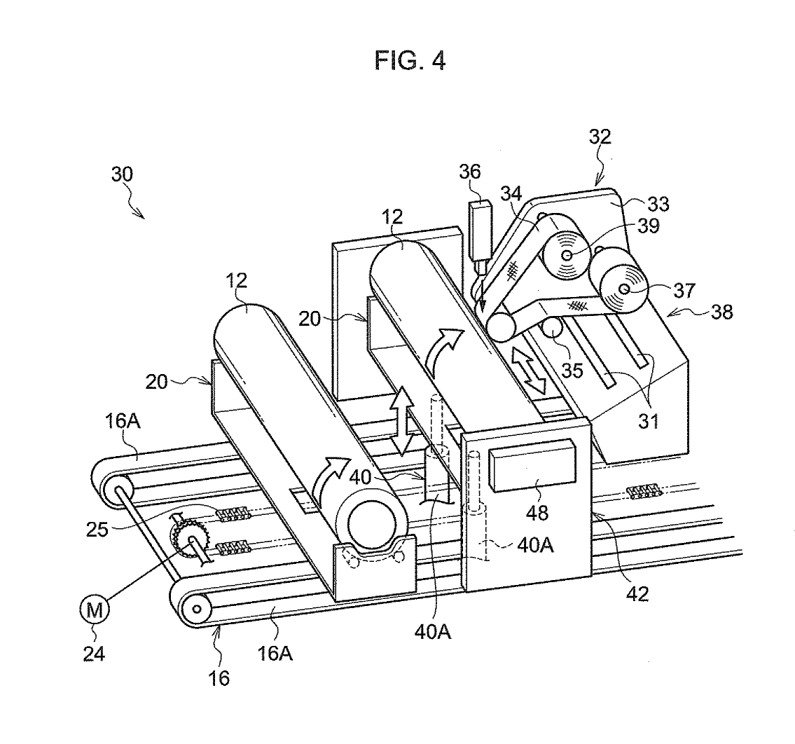

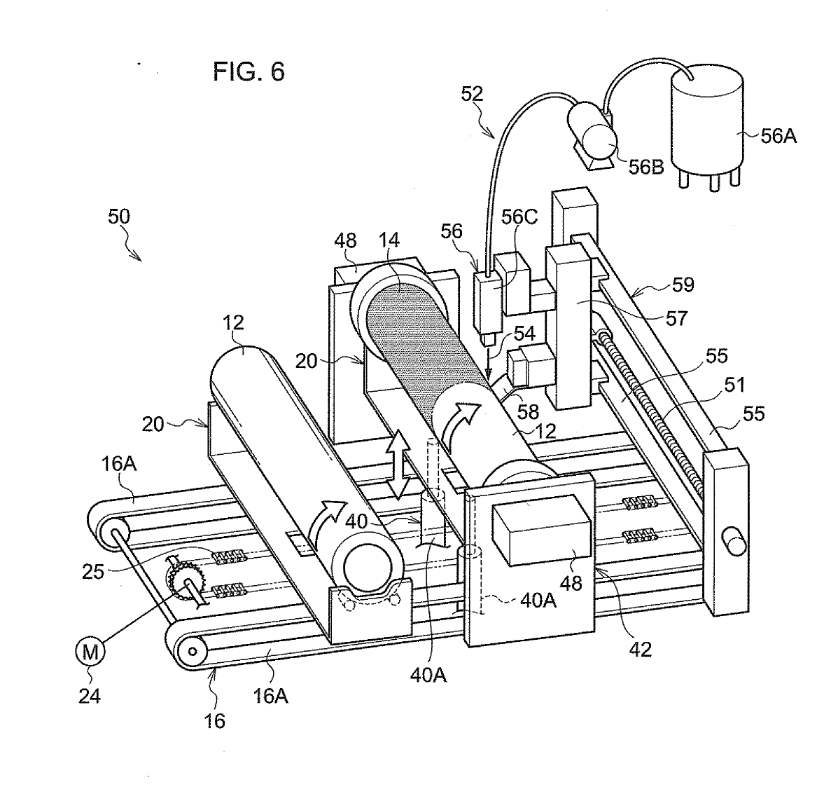

As shown in FIGS. 2 and 3, the supporting device 20 is structured to include plural rotating bodies 22 each rotating in contact with the outer peripheral surface of the core body 12 and imparting rotating force thereof to the core body 12, a gear train 26 serving as a transmitting member that transmits driving force from a driving portion 24 (see FIGS. 4 and 6) to the rotating members 22, and a supporting body 28 that supports the rotating bodies 22 and the gear train 26 in a rotatable manner.

The supporting body 28 is structured to include a pair of side plates 29, and a bottom plate 27 provided integrally with the side plates 29 between the pair of side plates 29. The rotating bodies 22 are respectively supported by the pair of side plates 29 between the side plates 29 in a rotatable manner, and the gear train 26 is supported by the pair of the side plates 29 or the bottom plate 27 in a rotatable manner.

Pairs of rotating bodies 22 are disposed at both end portions of the core body 12 in the axial direction thereof, respectively. The core body 12 placed on the rotating bodies 22 is supported by the rotating bodies 22 from the lower side.

The gear train 26 is structured in such a manner that a gear (sprocket) 26A, which is disposed at the most upstream side of the direction of transmitting of driving force, meshes with a chain 25, which moves in a circulatory manner (rotates) by the driving force of the driving portion 24, which is an example of a first rotating portion.

Hence, in the supporting device 20, the driving force of the driving portion 24 is transmitted to the rotating bodies 22 by the chain 25, which moves in a circulatory manner (rotates) and the gear train 26, so as to rotate the rotating bodies 22, and the core body 12 is made to rotate by rotation of the rotating bodies 22.

The transport section 16 is structured by a belt conveyor. The supporting device 20 is supported at the both end sides in the axial direction of the core body 12, and belts 16A move in a circulatory manner, whereby the supporting device 20 is transported in the order of the cleaning section 30, the applying section 50, the drying section 72 and the firing section 80. Even in a state in which the supporting device 20 is transported by the transport section 16, the driving force of the driving portion 24 is transmitted to the rotating bodies 22 by the chain 25, which moves in a circulatory manner (rotates), and the gear train 26, to cause the rotating bodies 22 to rotate. Then, the core body 12 is made to rotate due to rotation of the rotating bodies 22.

### (Structure of Cleaning Section 30)

As shown in FIG. 4, the cleaning section 30 is structured to include an elevating device 40 that moves up and down the core body 12, a rotating device 42 which holds the core body 12 moved up by the elevating device 40 and rotates the core body 12, and a cleaning device 32 that cleans the outer peripheral surface of the core body 12 which is rotated by the rotating device 42.

The elevating device 40 is provided with a pair of elevating members 40A that support the supporting device 20 at the both end sides in the axial direction of the core body 12 from the lower side, and that moves up and down the supporting device 20. In the elevating device 40, for example, due to the pair of elevating members 40A expanding and contracting (telescopic), the core body 12 is made to move up and down together with the supporting device 20. The core body 12 is moved up by the elevating device 40, so that a state in which the chain 25 which is an example of the transmitting member, and the gear train 26 are connected to each other is cancelled, whereby is disconnected from the driving portion 24 and is brought into a free state in which the driving force from the driving portion 24 is not imparted thereto. However, even in the state in which the core body 12 (the supporting device 20) is moved up by the elevating device 40, the core body 12 rotates with inertia. Further, the core body 12 moved upward is moved down by the elevating device 40, so that the driving force from the driving portion 24 can be imparted to the core body 12 due to the chain 25 and the gear train 26 being connected to each other.

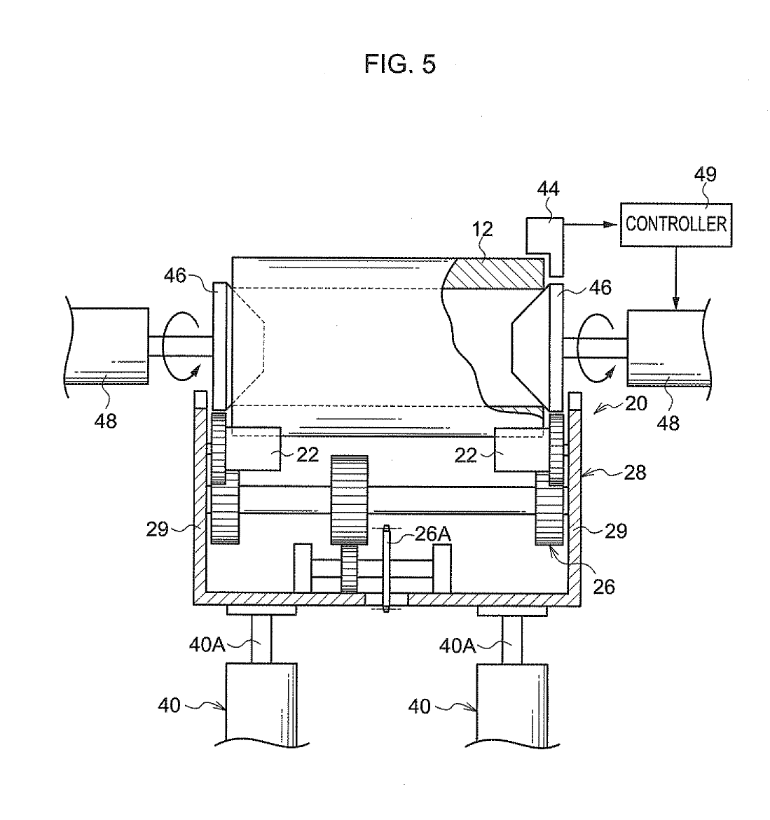

As shown in FIG. 5, the rotating device 42 is equipped with a detecting portion 44 which detects speed of rotation of the core body 12 rotating with inertia due to the elevating device 40, a pair of holding members 46 which hold the core body 12 rotating due to the elevating device 40 with inertia, rotating portions 48, which is an example of a second rotating portion, that rotate the pair of holding members 46 respectively, and a control portion 49 which controls the speed of rotation of the pair of holding members 46 on the basis of the result of detection of the detecting portion 44.

The detecting portion 44 is structured by, for example, a rotary encoder which detects the speed of rotation of the core body 12 rotating with inertia. The detecting portion 44 is not limited to the rotary encoder.

The rotating portions 48 are, for example, structured so as to include driving motors such as a servo motor, pulse motor and the like, in the pair of holding members 46 respectively. The driving motors cause the pair of holding members 46 to rotate respectively.

The control portion 49 controls the rotating portions 48 so that the pair of holding members 46 respectively rotate in the same direction and at the same speed of rotation. Further, the control portion 49 controls, based on the result of detection of the detecting portion 44, controls the rotating portions 48 so that the pair of holding members 46 rotates in the same direction and at the same speed of rotation as with the core body 12.

Incidentally, the rotating portions 48 may be structured in such a manner that driving force from a single driving portion is distributed to the pair of holding portions 46 by the gear train 26, so that the pair of holding portions 46 rotates in the same direction and at the same speed of rotation.

The pair of holding members 46 is made up from metal material such as aluminum, stainless steel (SUS) or the like. Further, the pair of holding portions 46 each has a leading end portion formed in the shape of a circular cone. The respective leading end portions of the holding portions 46 are inserted from the both end portions in the axial direction of the core body 12 into an internal space of the core body 12, and are each made to come into contact with the inner periphery of the end portion of the core body 12. As a result, the core body 12 is held by the pair of holding members 46, which rotates by the rotating portions 48, by being caught (sandwiched) from both end portions of the core body 12 in the axial direction. Further, the core body 12 is driven to rotate by the rotating portions 48 in the state of being held by the pair of holding portions 46. Incidentally, in a ease in which, for example, stainless steel (SUS) is used as the core body 12, preferably, the holding members 46 to which the core body 12 corresponds are each made from stainless steel (SUS) which is the same material as the core body 12.

As shown in FIG. 4, the cleaning device 32 is structured to include a waste 34 which is an example of wipe-out member which wipes out the outer peripheral surface of the core body 12 rotating by the rotating portions 48, a supplying portion 36 which supplies a cleaning liquid to the waste 34, and a moving mechanism 38 which moves the waste 34 and the supplying portion 36 along the axial direction of the core body 12 which is in the state of being held by the pair of holding portions 46.

The waste 34 is wound around a pullout roll 39 which is an example of a pullout member which pulls out the waste 34, and around a take-up roll 37 which is an example of a take-up member which takes up the waste 34 pulled out from the pullout roll 39, and also around a pressing roll 35 which is an example of pressing member which presses the waste 34 pulled out from the pullout roll 39 between the take-up roll 37 and the pullout roll 39 against the core body 12. The pullout roll 39, the take-up roll 37 and the pressing roll 35 are each supported by a supporting body 33 in a rotatable manner. A width of the waste 34 is made shorter than the axial length of the core body 12, and the waste 34 is structured so as to wipe out the outer peripheral surface of the core body 12 by coming into contact with a portion in the axial direction of the core body 12.

The supplying portion 36 is structured to discharge a cleaning liquid (for example, an organic solvent such as ethanol) to the waste 34 and supply the cleaning liquid to the waste 34. As a result, the outer peripheral surface of the core body 12 is wiped out by the waste 34 impregnated with the cleaning liquid. Incidentally, the supplying portion 36 may have a structure in which the cleaning liquid is directly supplied to the outer peripheral surface of the core body 12. The supplying portion 36 may use applying method other than the discharging method. Further, the cleaning liquid may be in advance immersed in the waste 34.

The moving mechanism 38 is structured in such a manner that the support body 33 and the supplying portion 36 are moved in an integrated manner along guides 31 formed along the axial direction of the core body 12 which is in the state of being held by the pair of holding members 46. As a result, in the cleaning device 32, while the waste 34 and the supplying portion 36 moving by the moving mechanism 38 in an integrated manner along the axial direction of the core body 12 rotating by the rotating portions 48, the waste 34 which is impregnated with the cleaning liquid wipes out the outer peripheral surface of the core body 12.

### (Structure of Applying Section 50)

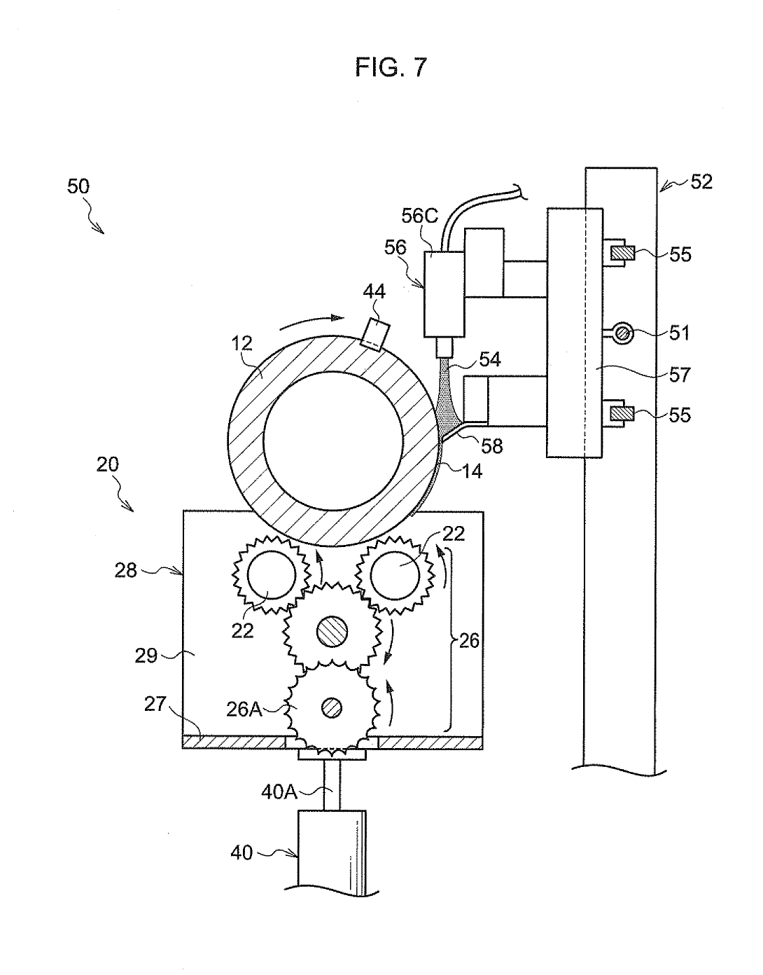

As shown in FIG. 6 and FIG. 7, the applying section 50 is structured to include an elevating device 40 which moves up and down the core body 12, a rotating device 42 which rotates the core body 12 moved up by the elevating device 40, and an applying device 52 which applies a resin solution 54 to the outer peripheral surface of the core body 12 which is rotated by the rotating device 42.

As similar with the case of the cleaning section 30, the elevating device 40 is provided with a pair of elevating members 40A that support the supporting device 20 at the both end sides in the axial direction of the core body 12 from the lower side, and that moves up and down the supporting device 20. In the elevating device 40, for example, due to the pair of elevating members 40A expanding and contracting (being telescopic), the core body 12 is made to move up and down together with the supporting device 20. The core body 12 is moved up by the elevating device 40, so that a state in which the chain 25 which is an example of the transmitting member, and the gear train 26 are connected to each other is cancelled, whereby is disconnected from the driving portion 24 and is brought into a free state in which the driving force from the driving portion 24 is not imparted thereto. However, even in the state in which the core body 12 (the supporting device 20) is moved up by the elevating device 40, the core body 12 rotates with inertia. Further, the core body 12 moved upward is moved down by the elevating device 40, so that the driving force from the driving portion 24 can be imparted to the core body 12 due to the chain 25 and the gear train 26 being connected to each other.

As shown in FIG. 5, the rotating device 42 is equipped with a detecting portion 44 which detects speed of rotation of the core body 12 rotating with inertia due to the elevating device 40, a pair of holding members 46 which hold the core body 12 rotating due to the elevating device 40 with inertia, rotating portions 48, which is an example of a second rotating portion, that rotate the pair of holding members 46 respectively, and a control portion 49 which controls the speed of rotation of the pair of holding members 46 on the basis of the result of detection of the detecting portion 44.

The detecting portion 44 is structured by, for example, a rotary encoder which detects the speed of rotation of the core body 12 rotating with inertia. The detecting portion 44 is not limited to the rotary encoder.

The rotating portions 48 are, for example, structured so as to include driving motors such as a servo motor, pulse motor and the like, in the pair of holding members 46 respectively. The driving motors cause the pair of holding members 46 to rotate respectively.

The control portion 49 controls the rotating portions 48 so that the pair of holding members 46 respectively rotates in the same direction and at the same speed of rotation. Further, the control portion 49 controls, based on the result of detection of the detecting portion 44, controls the rotating portions 48 so that the pair of holding members 46 rotates in the same direction and at the same speed of rotation as with the core body 12.

Incidentally, the rotating portions 48 may be structured in such a manner that driving force from a single driving portion is distributed to the pair of holding portions 46 by the gear train 26, so that the pair of holding portions 46 rotates in the same direction and at the same speed of rotation.

The pair of holding members 46 is made up from metal material such as aluminum, stainless steel (SUS) or the like. Further, the pair of holding portions 46 each has a leading end portion formed in the shape of a circular cone. The respective leading end portions of the holding portions 46 are inserted from the both end portions in the axial direction of the core body 12 into an internal space of the core body 12, and are each made to come into contact with the inner periphery of the end portion of the core body 12. As a result, the core body 12 is held by the pair of holding members 46, which rotates by the rotating portions 48, by being caught (sandwiched) from both end portions of the core body 12 in the axial direction. Further, the core body 12 is driven to rotate by the rotating portions 48 in the state of being held by the pair of holding portions 46. Incidentally, in a case in which, for example, stainless steel (SUS) is used as the core body 12, preferably, the holding members 46 to which the core body 12 corresponds are each made from stainless steel (SUS) which is the same material as the core body 12.

As shown in FIG. 6, the applying device 52 is structured to include a supplying portion 56 which supplies the resin solution 54 to the outer peripheral surface of the core body 12, a plate-shaped blade 58 which causes the resin solution 54 supplied by the supplying portion 56 to be made equalize (to be substantially flat) on the outer peripheral surface of the core body 12, and a moving mechanism 59 which moves the supplying portion 56 and the blade 58 along the axial direction of the core body 12 which is in the state of being held by the holding members 46.

The supplying portion 56 is structured in such a manner as to discharge the resin solution 54 stored in a storing portion 56A by a pump 56B from a discharging portion 56C and supply the resin solution 54 to the outer peripheral surface of the core body 12. The supplying portion 56 may use applying method other than the discharging method.

The blade 58 comes into contact with the outer peripheral surface of the core body 12 and equalizes the resin solution 54, whereby the film thickness of the applied film 14 formed by the resin solution 54 is made uniform. The blade 58 and the discharging portion 56C are supported by a supporting body 57.

The moving mechanism 59 is structured in such a manner as to transmit driving force to the supporting body 57 via a transmitting member 51 such as a ball screw or a belt along guides 55, which are formed along the axial direction of the core body 12 which is in the state of being held by the pair of holding members 46, so as to move the supporting body 57. As a result, in the applying device 52, the applied film 14 of the resin solution 54 is formed on the outer peripheral surface of the core body 12 while the discharging portion 56C and the blade 58 are moving by the moving mechanism 59 in an integrated manner along the axial direction of the core body 12 which is rotated by the rotating portions 48. Incidentally, supplying the resin solution 54 to the core body 12 is carried out in the state in which the supporting device 20 (the rotating bodies 22) is separated from the core body 12 due to the supporting device 20 being moved down by the elevating device 40.

### (Structure of Drying Section 72)

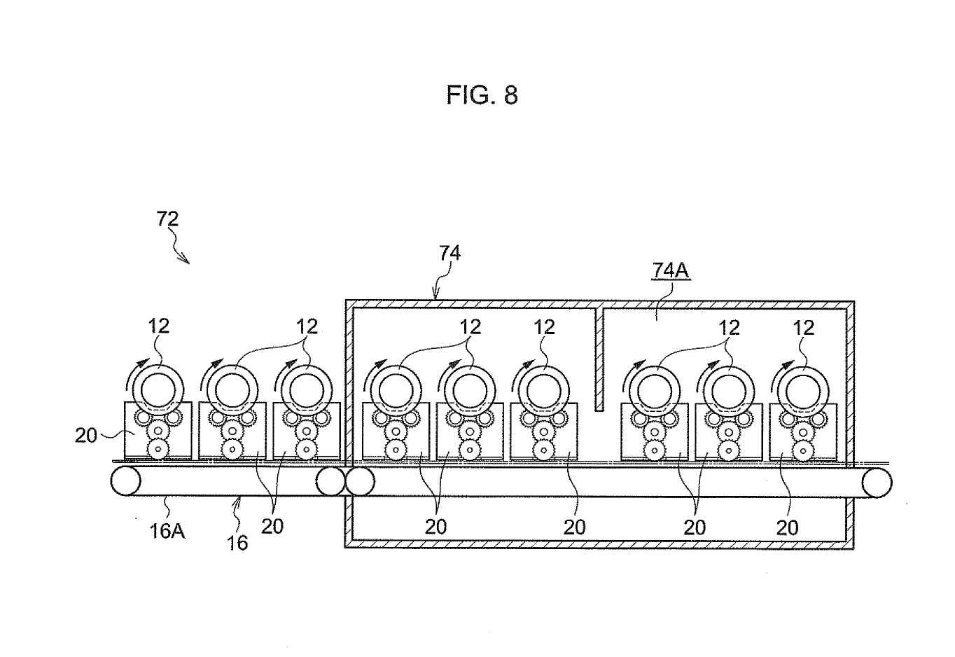

As shown in FIG. 8, the drying section 72 is equipped with a heating device 74 having inside an accommodation space 74A in which the supporting device 20 by which the core body 12 is supported can be accommodated. In the heating device 74, the supporting device 20 passes through the accommodation space 74 while the core body 12 is rotating so as to prevent liquid-dripping of the applied film 14, and water contained in the resin solution 54 is evaporated, whereby the applied film 14 is dried. As a result, the applied film 14 is hardened.

### (Structure of Firing Section 80)

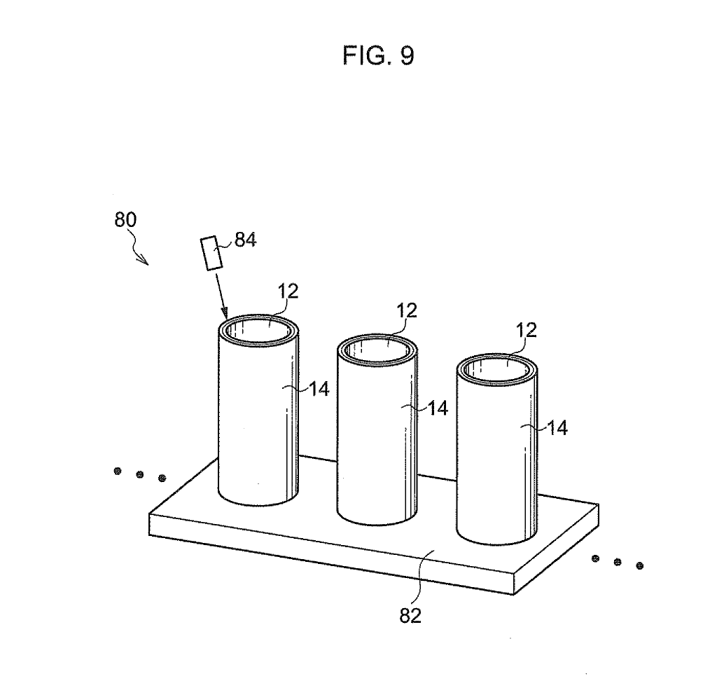

As shown in FIG. 9, the firing section 80 is equipped with a pedestal (board) 82 on which the core bodies 12 put down from the supporting device 20 are placed vertically. In the firing portion 80, the applied film 14 is fired (baked) by heating the core body 12 placed on the pedestal 82. As a result, the applied film 14 is hardened.

Incidentally, the core body 12 in which the applied film 14 is fired is cooled to room temperature, and thereafter, air is let in into a clearance between the fired applied film 14 and the axial-direction end portion of the outer peripheral surface of the core body 12 by an air inlet (filling) portion 84 which is an example of a mold removing (demold) portion, the fired applied film 14 is removed from the core body 12.

### (Method of Manufacturing of Annular Member)

Next, a method of manufacturing an annular member using an annular member manufacturing apparatus according to the present exemplary embodiment is described.

In the present manufacturing method, in the state in which the core body 12 is placed on the supporting device 20, the core body 12 is transported in the cleaning section 30 by the transport section 16 while rotating by driving force of the driving portion 24.

Next, in the cleaning section 30, the core body 12 is moved upward by the elevating device 40 together with the supporting device 20. As a result, the core body 12 is disconnected from the driving portion 24 and rotates with inertia (a core-body rotating step).

Then, the detecting portion 44 detects the speed of rotation of the core body 12 rotating with inertia (a detecting step). On the basis of the result of the detection, the rotating portions 48 are controlled by the control portion 49 (a control step), and the pair of holding members 46 rotates by the rotating portions 48 in the same direction and at the same speed of rotation as those of the core body 12 (a rotating step of holding members).

Next, the pair of holding members 46 rotating in the same direction and at the same speed of rotation as those of the core body 12 holds the inner peripheries at the end portions of the core body 12, respectively (a holding step). Subsequently, the speed of rotation of the pair of holding members 46 is increased gradually, so as to cause the speed of rotation of the core body 12 to increase. In this manner, a core body holding method that holds the core body 12 is carried out.

Then, while the waste 34 impregnated with the cleaning liquid is moved by the moving mechanism 38 along the axial direction of the core body 12 which is rotated by the rotating portions 48, the outer peripheral surface of the core body 12 which is rotated with being held by the pair of holding members 46 is wiped out (a cleaning step).

The supporting device 20 is moved downward by the elevating device 40, and is placed on the transport section 16. Subsequently, in the state in which the core body 12 is placed on the supporting device 20, the core body 12 is transported in the applying section 50 by the transport section 16 while rotating due to driving force of the driving portion 24.

Then, in the applying section 50, in the similar manner as in the cleaning section 30, the core body 12 is moved upward by the elevating device 40 together with the supporting device 20. As a result, the core body 12 is disconnected from the driving portion 24 and rotates with inertia (a core-body rotating step).

Then, the detecting portion 44 detects the speed of rotation of the core body 12 rotating with inertia (a detecting step). On the basis of the result of the detection, the rotating portions 48 are controlled by the control portion 49 (a control step), and the pair of holding members 46 rotates by the rotating portions 48 in the same direction and at the same speed of rotation as those of the core body 12 (a rotating step of holding member).

Then, the pair of holding portions 46 rotating in the same direction and at the same speed of rotation as those of the core body 12 holds the inner peripheries of the end portions of the core body 12 (a holding step). Subsequently, the speed of rotation of the pair of holding portions 46 is increased gradually, so as to cause the speed of rotation of the core body 12 to increase. In this manner, a core body holding method that holds the core body 12 is carried out.

While the discharging portion 56C and the blade 58 are moved by the moving mechanism 59 in an integrated manner along the axial direction of the core body 12 which is rotated by the rotating portions 48, the resin solution 54 is applied to the outer peripheral surface of the core body 12, thereby the liquid-like applied film 14 is formed (an applying step).

Then, the supporting device 20 is placed on the transport section 16 by being moved downward by the elevating device 40. Then, in the state in which the core body 12 is placed on the supporting device 20, the core body 12 is transported by the transport section 16 in the heating device 74 of the drying section 72 while rotating due to the driving force of the driving portion 24. The supporting device 20 passes through the accommodation space 74A of the heating device 74 and the applied film 14 is dried (a drying step).

In the firing section 80, the core body 12 put down from the supporting device 20 and placed on the pedestal 82 is heated and the applied film 14 is fired (a firing (baking) step).

As described above, in the present exemplary embodiment, the drying step and the firing step form a heating step in which the liquid-like applied film 14 is heated and hardened.

Then, the core body 12 with the applied film 14 being fired is cooled to room temperature, and thereafter, air is let in by the air inlet portion 84 into the clearance between the fired applied film 14 and the axial-direction end portion of the outer peripheral surface of the core body 12, whereby the fired applied film 14 is removed from the core body 12 (a removing step). Thus, the annular member is manufactured.

As described above, in the manufacturing method of the present exemplary embodiment, the pair of holding members 46 rotating in the same direction and at the same speed of rotation as those of the core body 12 holds the core body 12. Therefore, as compared to a case in which the core body 12 is held by the holding members 46 which do not rotate, generation of abrasive particles generated by friction of the core body 12 and the holding members 46 is suppressed. As a result, adhesion of the abrasive particles to the annular cylindrical member to be manufactured is suppressed.

Further, in the present exemplary embodiment, the speed of rotation of the core body 12 is increased after the core body 12 being rotating in a certain degree is held by the pair of holding members 46. Therefore, as compared to a case in which the speed of rotation of the core body 12 is increased from a non-rotating state, generation of abrasive particles generated by friction of the core body 12 and the holding members 46 is suppressed. As a result, adhesion of the abrasive particles to the annular member to be manufactured is suppressed.

Moreover, in the manufacturing method of the present exemplary embodiment, the pair of holding members 46 holds the inner peripheries of the end portions of the core body 12, respectively. Therefore, even if abrasive particles are generated due to friction of the core body 12 and the holding members 46, the peripheral speed of the core body is low and abrasion of the core body is small. In addition, abrasive particles are apt to remain at the side of the inner periphery of the core body 12. As a result, as compared to a case in which the inner peripheries of the end portions of a mold is not held, adhesion of abrasive particles to the annular member to be manufactured is suppressed.

Although the present exemplary embodiment has a structure in which the pair of holding members 46 holds the core body 12 which rotates with inertia, a structure in which the pair of holding members 46 holds the core body 12 in the state in which driving force is being imparted thereto from the driving portion 24 may also be provided.

Further, the present exemplary embodiment has a structure in which the core body 12 is made to move up together with the supporting device 20 to allow the core body 12 and the driving portion 24 to be disconnected from each other, but not limited to the same and a structure in which the core body 12 and the driving portion 24 are separated from each other so that they are disconnected from each other would be sufficient.

Moreover, in the present exemplary embodiment, a structure in which the pair of holding members 46 rotating in the same direction and at the same speed of rotation as those of the core body 12 which is rotating with inertia is provided. At least, it suffices that the pair of holding members 46 would rotate such that a difference between the speed of rotation of the pair of holding members 46 and that of the core body 12 which rotates with inertia is smaller than a difference between the speed of rotation of the pair of holding members 46 and that of the core body 12 whose speed of rotation is zero (that is, does not rotate). That is to say, it would be possible that there is a difference between the speed of rotation of the core body 12 which rotates with inertia and that of the pair of holding members 46 in a certain range.

It will be specifically described with reference to Examples and Comparative Examples, but it is not limited to the same.

### Example 1

As the core body 12, a stainless pipe whose inner diameter φ is 253 mm, whose length is 980 mm, whose thickness is 6.9 mm, and whose weight is 14 kg is prepared and is subjected to blast processing such that the outer peripheral surface thereof has Ra of 0.45 μm. After the surface of the core body 12 is degreased, and thereafter, a mixing liquid of a silicone-based mold release agent “SEPA-COAT” produced by Shin-Etsu Chemical Co., Ltd. and heptane is applied to the surface, and fired for 2 hours at 420° C. Further, after the core body 12 sufficiently get cool, the mixing liquid of the mold release agent and heptane is applied thereto again, and fired for 1 hour at 330° C. As a result, the mold release layer is formed on the outer peripheral surface of the core body 12, and the core body 12 whose outer peripheral surface has a mold releasing property is adjusted and prepared.

Using the core body 12 as adjusted above, the manufacturing method shown in the present exemplary embodiment is carried out in the annular member manufacturing apparatus 10 as shown above, and the annular member is manufactured.

Specifically, in a state in which the core body 12 is placed on the supporting device 20, the core body 12 is transported by the transport portion 17 in the applying section 50 while rotating by driving force of the driving portion 24 at 10 rpm. Next, in the applying section 50, the core body 12 is moved upward by the elevating device 40 together with the supporting device 20. As a result, the core body 12 is disconnected from the driving portion 24 and rotates with inertia (a core-body rotating step). Subsequently, the detecting portion 44 detects the speed of rotation of the core body 12 which is rotating with inertia (a detecting step). In this case, the detected speed of rotation is 9 rpm. On the basis of the result of the detection, the rotating portions 48 are controlled by the control portion 49 (a control step), and the pair of holding members 46 are rotated by the rotating portions 48 in the same direction and at the same speed of rotation (9 rpm) as those of the core body 12 (a rotating step of holding members). Then, the pair of holding members 46 rotating in the same direction and at the same speed of rotation as those of the core body 12 holds the inner peripheries of the end portions of the core body 12, respectively, with a pressure of 0.3 MPa (a holding step). Subsequently, the speed of rotation of the pair of holding members 46 is increased gradually so the speed of rotation of the core body 12 is increased from 9 rpm to 99.7 rpm over 2 seconds.

In the applying section 50, as the resin solution 54, a mixing liquid of 20 part by weight of carbon dispersed in 100 part by weight of a PI precursor solution having a viscosity of 50 Pa·s at 25° C. (trade name: U imide, produced by Unitika Ltd.) is used. Further, as the condition of forming a film in the applying section 50, the resin solution 54 is supplied from a nozzle whose diameter (inner diameter) is 2 mm and whose length is 10 mm to the outer peripheral surface of the core body 12 with using a NEMO Pump as the pump 56B. Further, the speed of rotation of the core body 12 is 99.7 rpm (number of revolution), and the moving velocity of the discharging portion 56C and the blade 58 (the speed at which they move in the axial direction of the core body 12) is set at 229 mm/minute.

Further, in the drying section 72, the core body 12 is put in the heating device 74 of 130° C. together with the supporting device 20 while it is being rotated at 10 rpm, and dried for 23 minutes.

In the firing section 80, in a state in which the core body 12 is placed vertically on the pedestal 82, the core body 12 is heated in a condition where temperature is raised to 125° C., 185° C., 230° C. and 260° C. sequentially for 27.5 minutes for each temperature, thereby causing the applied film 14 of a polyimide resin to be fired. Then, it is cooled to room temperature, and thereafter, the fired applied film 14 is removed from the core body 12 and an endless belt as an annular member is manufactured.

The endless belt thus obtained has an average film thickness of 80 μm and is good quality, that is, in the front surface of the belt, there is not defective such as swelling, concave and the like. The reverse surface of the belt has a desired roughness. At the endless belt being used as a transfer belt in a color electrophotographic apparatus, even if continuous rotation is carried out, no stain and accumulation toner exists on the surface of the transfer belt, thereby obtaining printed matters of excellent image quality with no image defects. No defective caused by metallic particles are found.

### Example 2

In the manufacturing method carried out by the annular member manufacturing apparatus 10 in Example 1 as described above, in Example 2, the speed of rotation of the core body 12 detected by the detecting portion 44 is 5 rpm. In Example 2, on the basis of the result of this detection, the rotating portions 48 are controlled by the control portion 49 (a control step), and the pair of holding members 46 rotates by the rotating portions 48 in the same direction as that of the core body 12 and at the speed of rotation of 9 rpm (a rotating step of holding members). Next, the pair of holding members 46, which rotates in the same direction as that of the core body 12, holds the inner peripheries of the end portions of the core body 12 at the pressure of 0.3 MPa (a holding step). Then, the speed of rotation of the pair of holding members 46 is increased gradually and the speed of rotation of the core body 12 is increased from 9 rpm to 99.7 rpm over 2 seconds.

The rate of occurrence of failure of the endless belt thus obtained is about 1%. This rate of occurrence of failure is inferior to Example 1, but it is a small rate of occurrence of failure which failure may be ignored.

### Comparative Example 1

In the manufacturing method carried out by the annular member manufacturing apparatus 10 in Example 1 as described above, in Comparative Example 1, the core body 12 rotating at the speed of rotation of 9 rpm is held by the pair of holding members 46 which does not rotate. Next, the speed of rotation of the pair of holding members 46 is increase gradually, and the speed of rotation of the core body 12 is increased to 99.7 rpm over 2 seconds.

As a result, the endless belt thus obtained has defect of metallic particles, and projections are formed on the surface of the endless belt.

At the endless belt being used as a transfer belt in a color electrophotographic apparatus, an image is obtained where defective portion is found at the same position as that at which metallic particle exists. The defective endless belts having such failures as described above are manufactured so as to be about 6% of all of the belts. It is found that if the core body is rotated by the holding members, which are in a state of not rotating, holding the core body, a large volume of abrasive particles are generated.

### Comparative Example 2

In the manufacturing method carried out by the annular member manufacturing apparatus 10 of Example 1 as described above, in Comparative Example 2, the core body 12 is in a state of not rotating, and the core body 12 in the state of not rotating is held by the pair of holding members 46 in the state of not rotating. Next, the number of the rotations of the pair of holding members is increased gradually and the speed of rotation of the core body 12 is increased to 99.7 rpm over 2 seconds.

As a result, the rate of occurrence of failure of the endless belt thus obtained is about 3%. This rate of occurrence of failure is smaller than that of Comparative Example 1, but it is found that even if the core body 12 in the state of not rotating is rotated by the holding members in the state of not rotating, abrasive particles are generated.

The present invention is not limited to the aforementioned exemplary embodiments, and various modifications, changes and improvement are possible.

What is claimed is:

1. A metal mold holding method comprising:
rotating a metal mold by a first rotating portion;
rotating a holding member by a second rotating portion in the same direction as that of the metal mold such that a difference between a speed of rotation of the holding member and that of the metal mold which rotates is smaller than a difference between the speed of rotation of the holding member and that of the metal mold in a case where the speed of rotation of the metal mold is zero; and
holding the metal mold which rotates by the holding member which rotates.

2. The metal mold holding method of claim 1, further comprising:
rotating the metal mold with inertia by disconnecting of connection of the first rotating portion and the metal mold;
detecting the speed of rotation of the metal mold which rotates with inertia; and
controlling the speed of rotation of the holding member based on the detected speed of rotation of the metal mold which rotates with inertia.

3. The metal mold holding method of claim 1, wherein
the metal mold is formed into a circular column or a circular pipe, and at least both end portions in an axial direction of the metal mold are formed into a circular pipe, and
the holding member holds inner peripheries of the both end portions of the metal mold.

4. The metal mold holding method of claim 2, wherein
the metal mold is formed into a circular column or a circular pipe, and at least both end portions in an axial direction of the metal mold are formed into a circular pipe, and
the holding member holds inner peripheries of the both end portions of the metal mold.

5. The metal mold holding method of claim 1, wherein the metal mold which rotates is held by the holding member which rotates at the same speed of rotation as that of the metal mold which rotates.

6. The metal mold holding method of claim 2, wherein the metal mold which rotates with inertia is held by the holding member which rotates at the same speed of rotation as that of the metal mold which rotates with inertia.

7. An annular member manufacturing method, comprising:
applying a liquid to an outer peripheral surface of a metal mold formed into a circular column or a circular pipe, while rotating the metal mold which is held by a holding member using a metal mold holding method including rotating the metal mold by a first rotating portion, rotating the holding member by a second rotating portion in the same direction as that of the metal mold such that a difference between a speed of rotation of the holding member and that of the metal mold which rotates is smaller than a difference between the speed of rotation of the holding member and that of the metal mold in a case where the speed of rotation of the metal mold is zero, and holding the metal mold which rotates by the holding member which rotates, by the second rotating portion;
heating the applied liquid to harden the applied liquid; and
removing the hardened liquid from the metal mold.

8. The annular member manufacturing method of claim 7, wherein
at least both end portions in an axial direction of the metal mold are formed into a circular pipe, and
the holding member holds inner peripheries of the both end portions of the metal mold.

9. The annular member manufacturing method of claim 7, wherein the metal mold holding method further includes
rotating the metal mold with inertia by disconnecting of connection of the first rotating portion and the metal mold;
detecting the speed of rotation of the metal mold which rotates with inertia; and
controlling the speed of rotation of the holding member based on the detected speed of rotation of the metal mold which rotates with inertia.

10. An annular member manufacturing apparatus, comprising:
a first rotating portion that rotates a metal mold formed into a circular column or a circular pipe;
a holding member that holds the metal mold while the holding member rotates in the same direction as that of the metal mold such that a difference between a speed of rotation of the holding member and that of the metal mold which rotates by the first rotating portion is smaller than a difference between the speed of rotation of the holding member and that of the metal mold in a case where the speed of rotation of the metal mold is zero;
a second rotating portion that rotates the holding member;
an applying section that applies a liquid to an outer peripheral surface of the metal mold which is rotated by the holding member;
a heating section that heats the liquid applied by the applying section to harden the liquid; and
a removing section that removes the liquid hardened by the heating section from the metal mold.

11. The annular member manufacturing apparatus of claim 10, wherein
the metal mold is rotated with inertia by disconnecting of connection of the first rotating portion and the metal mold,
a detecting section detects the speed of rotation of the metal mold which rotates with inertia, and
a controlling section controls the speed of rotation of the holding member based on the detected speed of rotation of the metal mold which rotates with inertia.

12. The annular member manufacturing apparatus of claim 10, wherein
at least both end portions in an axial direction of the metal mold are formed into a circular pipe, and
the holding member holds inner peripheries of the both end portions of the metal mold.
